(19) United States
(12) Patent Application Publication
(10) Pub. No.: US 2004/0121182 A1
(43) Pub. Date: Jun. 24, 2004

(54) Method and composition to repair and build structures

(76) Inventors: Canan Uslu Hardwicke, Niskayuna, NY (US); Melvin Robert Jackson, Niskayuna, NY (US); Michael Francis Xavier Gigliotti, JR., Glenville, NY (US)

Correspondence Address: Philip D. Freedman, Philip D. Freedman PC, P O Box 19076, Alexandria, VA, 22320, US

(21) Appl. No.: 10/326,618

(22) Filed: Dec. 23, 2002

(51) Int. Cl. B32B 15/00; B05D 3/02

(52) U.S. Cl. 428/680; 29/889.1; 428/553; 427/376.1; 427/376.2

(57) ABSTRACT

A method to apply a material layer, comprises selecting a first material with a first melting temperature and a second material composition having a second melting temperature at least 40° C. lower than the first melting temperature; forming a suspension comprising the first material and second material composition in a carrier medium; depositing the suspension onto a surface to form a layer; and controllably heating the layer to a temperature at least 20° C. above the melting temperature of the second material composition but no higher than 20° C. below the melting temperature of the first material, to dissolve at least some of the first material in melted second material composition. A composition of matter, comprises a first material with a first melting temperature and a second material composition having a second melting temperature at least 40° C. lower than the first melting temperature and a carrier medium. Another composition of matter comprises a deposited free-form line of a first material with a first melting temperature and a second material composition comprising a combined second material and a melting temperature suppressant, the second material composition having a second melting temperature at least 40° C. lower than the first melting temperature. Another composition of matter comprises a deposited free-form line of a first material with a first melting temperature and a second material composition comprising a combined second material and a melting temperature suppressant, the second material composition having a second melting temperature at least 40° C. lower than the first melting temperature, the line being controllably heated to a temperature at least 20° C. above the melting temperature of the second material but no higher than 20° C. below the melting temperature of the first material. A structure comprises consecutively deposited free-form lines produced by: selecting a first material with a first melting temperature and a second material composition having a second melting temperature at least 40° C. lower than the first melting temperature; forming a suspension comprising the first material and second material composition in a carrier medium; depositing the suspension onto a surface to form a layer; and controllably heating the layer to a temperature at least 20° C. above the melting temperature of the second material composition but no higher than 20° C. below the melting temperature of the first material, to dissolve at least some of the first material in melted second material composition.

### BACKGROUND OF THE INVENTION

The invention relates to a method and composition to repair and build structures, and to these structures and their composition after building.

Direct write deposition is a cost-effective process for deposition of thin films. This process involves the preparation of a solution of a powder (generally less than 45 microns in size) of the material to be coated. The solution is dispensed from a dispensing system onto a substrate and is hardened into a film. A typical structure-forming dispensing system includes a source of material, a material deposition system such as a nozzle, a material receiving platform, and means for moving the platform in at least one direction with respect to the deposition system under the control of a computer. The material typically flows through the nozzle as either a powder or a liquid and is hardened by some process when it hits the platform or a previous hardened layer of material. Objects are formed by dispensing and hardening successive slices of the final object.

The layers or lines obtained by this process are generally limited in thickness, typically a few microns, but less than ten microns. Attempts to deposit thicker layers are unsuccessful because of cracking, particularly during the hardening step. In addition, colloidal processes usually require a hardening step that involves sintering at high temperature to densify the layer. The process of thermal cycling of a substrate from room temperature to the sintering temperature, can cause cracking between the successive layers because of differential rates of thermal expansion.

There are certain critical parameters relating to a slurry process. For example, process requires rapid flow of material from the dispenser nozzle and even distribution of material with rapid hardening of the medium carrying the suspended powders after deposition. Additionally, as multiple layers are applied, they must flow together sufficiently to form a unitary structure, but not flow so much as to distort the shape of the structure. Lastly, the deposited structure should be relatively quickly hardened to a final form that is free of voids.

Limitations in thickness and the criticality of process parameters have prevented using slurry processes to form complex structures with multiple angled surfaces, cornices, minute detailed characteristics and varying surfaces. Such structures are typically found in the turbine generator and engine industries.

Accordingly, a need exists for dense crack-free coatings that can be used for repair. Additionally, there is a need for a process to provide sufficiently thick and dense structures that can be used to “build” various complex structures, particularly turbine engine structures.

### BRIEF DESCRIPTION OF THE INVENTION

The invention provides a method to produce dense crack-free coatings that can be used for repair. Additionally, the invention relates to a process to provide sufficiently thick and dense layer-wise fabrications that can be used to “build” complex structures. According to the invention, a method to apply a material layer, comprises selecting a first material with a first melting temperature and a second material composition having a second melting temperature at least 40° C. lower than the first melting temperature; forming a suspension comprising the first material and second material composition in a carrier medium; depositing the suspension onto a surface to form a layer; and controllably heating the layer to a temperature at least 20° C. above the melting temperature of the second material composition but no higher than 20° C. below the melting temperature of the first material, to dissolve at least some of the first material in melted second material composition.

The invention also relates to a composition of matter, comprising a first material with a first melting temperature and a second material composition having a second melting temperature at least 40° C. lower than the first melting temperature and a carrier medium and to a composition of matter, comprising a deposited free-form line of a first material with a first melting temperature and a second material composition comprising a combined second material and a melting temperature suppressant, the second material composition having a second melting temperature at least 40° C. lower than the first melting temperature.

The invention also relates to a composition of matter, comprising a first material with a first melting temperature and a second material composition having a second melting temperature at least 40° C. lower than the first melting temperature and a carrier medium and to a composition of matter, a deposited free-form line of a first material with a first melting temperature and a second material composition comprising a combined second material and a melting temperature suppressant, the second material composition having a second melting temperature at least 40° C. lower than the first melting temperature, the line being controllably heated to a temperature at least 20° C. above the melting temperature of the second material but no higher than 20° C. below the melting temperature of the first material.

The invention also relates to a structure comprising consecutively deposited free-form lines produced by selecting a first material with a first melting temperature and a second material composition having a second melting temperature at least 40° C. lower than the first melting temperature; forming a suspension comprising the first material and second material composition in a carrier medium; depositing the suspension onto a surface to form a layer; and controllably heating the layer to a temperature at least 20° C. above the melting temperature of the second material composition but no higher than 20° C. below the melting temperature of the first material, to dissolve at least some of the first material in melted second material composition.

### BRIEF DESCRIPTION OF THE DRAWING

FIG. 1 is a schematic representation of a method and device for carrying out the invention;

FIG. 2 is a schematic representation of a part that is repaired by the method and device of the invention;

FIG. 3 is a schematic representation of a method to deposit a thin material coating to repair an article or to layer-wise fabricate a three-dimensional article;

FIGS. 4A through 4G are surface sections showing fabricated lines of various compositions;

FIG. 5 is a line surface after heat treatment shown at 1000 magnification;

FIG. 6 is a cross section of a line after heat treatment shown at 250 magnification; and

FIG. 7 is a schematic representation of temperature and percent second material ranges.

### DETAILED DESCRIPTION OF THE INVENTION

The invention advantageously provides coatings and deposits that can be used to repair or to build new complex structures for numerous applications including any application to apply a chemically inert protective coating of metal, oxide, silicide, nitride or carbide material. For example, the invention can be used to repair or build fuel cells, sensors, turbine component coatings, dielectric coatings and other structures. Preferably, the invention provides layers to repair or build turbine engine parts such as airfoils, angel wings, vanes and shrouds.

Features of the invention will become apparent from the drawings and following detailed discussion, which by way of example without limitation describe preferred embodiments of the invention.

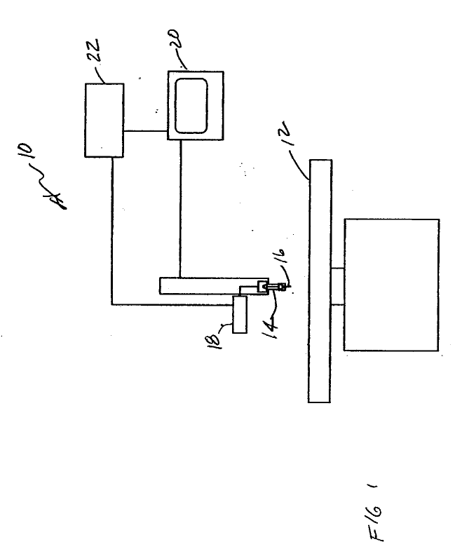

FIG. 1 shows a system 10 for free-forming a part according to a method of the invention. The FIG. 1 system 10 includes a moveable platform 12 and a material depositing device 14 that includes a nozzle 16 for expressing a colloidal suspension when activated by syringe pump 18 to deposit a layer onto the platform 12. The system also includes a controller 20, which can be a personal computer or the like, to control a supply of colloidal suspension from source 22 to syringe pump 18. Controller 20 also controls the movement of platform 12 in X, Y directions and the movement of the depositing device 14 in a Z direction, perpendicular to the platform 12 and correspondingly perpendicular to a part that is repaired or built on the platform 12. The platform 12 can be driven by a threaded rod or the like in the X or Y direction. Alternatively, platform 10 may be fixed and device 14 can be affixed to a robotic arm moveable in any direction. Depositing device 14 can be a syringe that has a hollow cylindrical body 24 enclosing a piston 26 which moves along the axis of cylinder 24 under the control of an actuator (not shown) controlled by controller 20. The movement of device 14 with respect to platform 12 and movement of piston 26 within cylinder 24 and the movement of the platform 12 itself can be controlled by a programmed computer at controller 20.

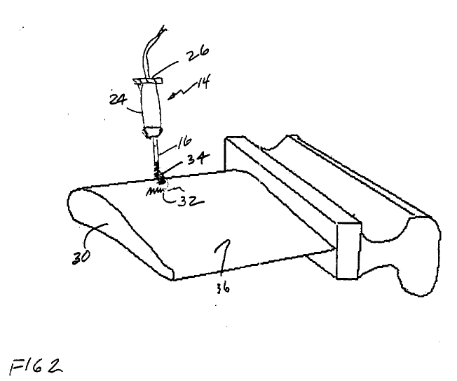

FIG. 2 shows a typical part that can be repaired or built by the inventive process. In FIG. 2 the part is an airfoil 30 that is shown with a coating repair area designated 32 that is formed from colloidal suspension 34 that is expressed from nozzle 16 of depositing device 14. While FIG. 2 illustrates a part repair, a part can be built according to the invention by sequentially depositing a plurality of layers from device 14 as it moves relative to a forming surface 36 of the part in a desired pattern.

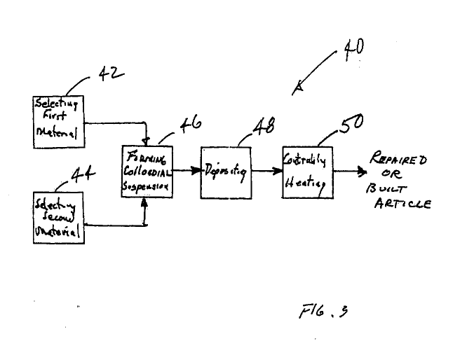

FIG. 3 is a schematic representation of a method 40 to deposit a thin material coating to repair an article or to layer-wise fabricate a three-dimensional article using the system of FIG. 1. In the method 40, a stable suspension containing at least two powders that form a coating and a carrier medium are combined and denosited to form a layer. Referring to FIG. 3T, in the method 40, a first material with a first melting temperature is selected 42 and a second material with a second melting temperature is selected 44, wherein the second material melting temperature is at least 40° C. below that of the first material, preferably at least 80° C. below that of the first material, and most preferably at least 120° C. below that of the first material.

The suspension for forming a three-dimensional article or for repairing a structure comprises at least a first material and a second material composition. The first material has a first melting temperature and the second material composition has a second melting temperature that is at least 40° C. lower than the first melting temperature. The first material and second material composition can be any coating-forming or structure-forming material that can be comminuted to a small enough particle size to be suspended—in a carrier medium. The suitable materials comprise particulate or powder forms in an average particle size sufficiently small enough to form a stable solution or suspension. The particles of the material can be <25 microns in average particle size. Preferably the material is a powder that is <10 microns in average particle size. In some instances the particles can be <5 microns and even <1 micron in size. Although any concentration of particles can be suspended in the carrier medium, usually the concentration of the combination of first and second materials is in the range from about 60 to 96 weight percent, of particles in the carrier. The range from about 70 to 94 weight percent of particles in the carrier is desired, and the range from about 80 to 92 weight percent is preferred.

Suitable materials include single or mixed metals or compounds, particularly ceramic precursor materials as for example, a metal, metal oxide, carbide, nitride or silicide. Suitable combinations of materials include (1) a Ni-base superalloy powder first material with a melting point in excess of 1225° C. and a Ni-base lower-melt alloy as the second material. The second material can include a melting point suppressing additive. Suitable additives include Si, B, Ti, Cr, Pd, Au and Ga. Another example is (2) an Fe, Cr-base stainless steel first material with a melting point in excess of 1300° C. and a Mn, Ni-base lower-melt alloy second material. For example, the Mn, Ni-base alloy can be 60 Mn-40 Ni. Another example is (3) a Ni powder first material with a melting point of 1450° C. and a Mn, Ni-base lower-melt alloy second material. Another example is (4) a platinum group metal (PGM) first material with melting point in excess of 1500° C. and a lower-melt alloy of Au, Ag, Au alloy or Ag alloy. For example, the PGM can be Rh, Pt, Ir or Pd. Another example is (5) a ceramic first material with melting point in excess of 1300° C. and a lower-melting second material composition. Another example is (6) a ceramic selected from alumina, magnesia and a non-oxide ceramic first material with melting point in excess of 1300° C. and a lower-melting oxide second material such as a boron-silicate glass. Still another example is (7) a mixture of a conductive oxide such as lanthanum strontium manganate with an Fe, Cr-base stainless steel first material with melting point in excess of 1300° C. and a mixture of an Fe, Cr-base stainless steel powder with a melting point suppressant such as B and Si, with a Mn,Ni-base low-melt alloy such as 60 Mn-40 Ni second material composition. Still another example is (8) a Ag-base powder with melting point in excess of 800° C. first material and a lower-melt alloy such as Bi—Sn or Bi—Cd second material composition. Another example is (9) a fibrous ceramic first material with melting point in excess of 1400° C. selected from silicon carbide, a silicon-based non-oxide, and alumina ceramic and a lower-melting second material composition.

The materials are mixed with a carrier medium to produce a paste that can be direct-written through a depositing device 14 to a substrate to form a line. The carrier medium employed to suspend the particles can be an organic liquid solvent, aqueous liquid solvent or a mixture of both. The selection of the solvent is determined by the materials to be deposited as well as the substrate. The solvent should be compatible with the particles so that a stable dispersion can be obtained. The solvent should have sufficient volatility so that it can easily be removed. Organic solvents such as ethanol, acetone, propanol, toluene are suitable. A dispersant, binder or plasticizer can be added to the solvent. A dispersant aids in stabilizing the suspension; a binder can add strength to a green deposited layer; and a plasticizer imparts some plasticity to the layer. When water is used, an organic solvent can be added to increase solvent volatility and enhance surface wetting properties.

Nozzle 16 orifice size, relative velocity of deposit and the paste viscosity control the direct-written line dimensions. The orifice defines the cross section of the flow of paste, and the line velocity defines how that cross section is distributed. A faster line velocity results in a smaller line height. The paste viscosity defines how much material is delivered through the orifice, and how much spreading of the written line occurs before the carrier in the line hardens. A more viscous paste delivers less material per unit time, so that line height is smaller, but it also results in less spreading of the written line. The ranges of suitable parameters for velocity and viscosity, are very material-specific, and are inter-dependent. The paste is applied to a substrate in a “green” form. The carrier medium is chosen to be removable by evaporation, decomposition, and/or burning, to produce a loosely connected powder assembly. The medium should fully harden at room temperature within a day, and should be totally removed after one hour at 700° C.; a medium that fully hardens at room temperature within 2 hours, and that is totally removed after one hour at 400° C. is desirable; a medium that fully hardens at room temperature within 20 minutes, and that is totally removed after one hour at 150° C. is preferred.

After the particles have been dispersed upon the substrate, the resulting line green form is sintered at times and temperatures sufficient to produce a final coating or structure having desired properties. The deposited materials are heated to a temperature at least 20° C. above the melting temperature of the second material but no higher than 20° C. below the melting temperature of the first material, which is sufficient to melt the second material particles, resulting in at least a partial dissolution of the first material particles into the second material particle melt. Consequently, the dissolved first material dilutes the second material melt thereby elevating the solidification temperature of the combined second material with dissolved first material. While it is not necessary to the invention that the time at temperature is sufficient for the second material dilution to result in re-solidification at a selected heating temperature, re-solidification during time at temperature is desired for many applications. The materials can be held at the controlled temperature for a time sufficient to allow at least partial alloying of the first and second materials and at least partial structural densification. The temperature and time of the thermal treatment, the particle sizes of the first and second materials and their melting temperatures relative to each other and relative to the heat treatment temperature, and the volume percent of the second material all govern the final density and microstructure. Densification rate is increased as the particle size decreases, as the volume percent of the second material is increased, as the thermal treatment temperature approaches the melting temperature of the first material, and as the difference in melting temperatures of the first and second materials increases. The time length of the thermal treatment is selected based on this relation and based on the acceptable final density.

For structural applications, temperature and time are selected to achieve >96% of theoretical density, while for a sensor application, conditions are selected to achieve >85% of theoretical density. Theoretical density p is derived from the crystal structure of the material, the lattice constants, and the average atomic weight A_{avg} of the composition. For a pure element, such as Ni, with a face centered cubic unit cell,

ρ_{Ni}=((atoms/unit cell)/(unit cell volume))·((A_{avg} g/mole)·(mole/6.02·10²³ atoms))=(4 /43.76 10⁻²⁴ cm³)·(58.69 g /6.02·10²³)=8.9 g/cm³.

For an alloy, a proportional average of atomic weights can be used to define theoretical density. If multiple phases are present, the theoretical density will be a volume averaging of respective densities of the phases. Any defect, such as a void or a crack in a structure, can result in an apparent density less than the theoretical density. For loosely packed spherical powders, the space between the powder particles can account for a very large part of the nominal volume, so that the apparent density is only about 65% of the theoretical density. During sintering, atomic rearrangements occur by surface and bulk diffusion that cause densification, or the elimination of some or all of the voids between particles. With a liquid present, such as when the second material is melted, the rate of densification is increased by the fluid movement to wet the solid particles of the first material, and by the enhanced diffusion rates that are found for liquids as compared to solids.

Typically, the heating is controlled to maintain temperature of the combined second material with dissolved first material until at least 85% of theoretical density (<15% residual porosity) is attained, as measured from the weight of the thermally treated deposit divided by the nominal volume as defined by the outer dimensions of the deposit. Desirably, the heating is controlled to maintain temperature until preferably at least 90% of theoretical density (<10% residual porosity) is attained. The combination of first and second materials and controlled heating step provides an alloyed essentially homogenous phase coating or built structure once the density reaches or exceeds 96% of theoretical density (<4% residual porosity).

Using the present method, a layer several microns to several hundred microns in thickness can be deposited in a single step. Or, a complex three-dimensional layer can be fabricated by the deposit of successive layers. Simple or complex structures can be created by controlling the composition of the solution delivered to the depositing device nozzle 16. Composites of different materials or coatings with graded compositions, including continuous grading or discontinuously grading can be fabricated.

A substrate comprising any material can be coated by the method, including for instance, glass, metal and ceramic substrates. A substrate surface can be in any shape, for example planar or non-planar. Following the depositing step, a substrate and an applied layer can be co-heated at controlled temperature to form a fully dense, sintered structure.

Multilayer coatings can be created using sequential processing of different solutions, each containing one or more compositions desired in the final coating. The solutions can be delivered to a single depositing device as shown in FIG. 1 or via a plurality of devices. A deposited layer can be graded in a continuous or discontinuous manner. A coating of continuously graded or discontinuously graded or stepped composite can be formed by a layer-wise deposit process. For example, a graded composition structure can be formed by simultaneously processing different solutions and controlling the pumping speed of the different solutions through the same or different depositing device.

Typical three-dimensional structures that can be prepared by a layer-wise fabrication according to the invention or structures that can be repaired include turbine blade tips, turbine nozzles, component parts of a conductive interconnect structure in a solid oxide fuel cell, a turbine blade or vane coating, a shell structure of a spar-shell airfoil or shroud, and component parts of a sensor system.

Suitable materials for these three-dimensional structures include (1) a Ni-base superalloy comprising 4-8.5a/oCo, 9-1Sa/oCr, 12-16a/oAl, 0.3-0.8a/oB, 1.5-5.0a/oSi, 0.7-1.1a/oW, 1.1-1.6a/oTa, 0.3-0.5a/oRe, 0.02-0.05Hf; (2) an Fe-based alloy comprising 18-26a/oCr, 2.5-8.5a/oMn, 1-3.5a/oNi, 0.1-1a/oTi, 0.01-0.1a/o of an element selected from La, Y, Zr, Ce, Nd, Dy, and Gd; (3) a Ni alloy comprising 2.5-10a/o Mn; (4) a Rh-base alloy comprising 20-50a/o of an element selected from Pd and Pt, or combinations thereof, and 5-15a/o of an element selected from Au and Ag, or combinations thereof; (5) an alumina material with 5-25 volume percent of Cr; (6) a ceramic base selected from alumina, magnesia, zirconia, yttria-stabilized zirconia, or combinations thereof, with 5-25 volume percent of a silicate glass; (7) an Fe-base alloy comprising 18-26a/oCr, 0.3-0.8a/oB, 1.5-5.0a/oSi, 0.1-1a/oTi, 0.01-0.06 a/o of an element selected from La, Y, Zr, Ce, Nd, Dy, and Gd, and 10-35 volume percent of a conductive oxide selected from MnCr2O4, lanthanum strontium manganate (such as [La_{0.75-0.9}Sr_{0.1-0.25}]_{0.9-1.0}Mn₁O₃), and lanthanum chromate; (8) a Ag-base alloy comprising 2-9a/oBi, and 2-9a/o of an element selected from Cd and Sn, or combinations thereof; (9) a fibrous silicon carbide with 5-25 volume percent of a silicon carbide formed from the second material composition of equal atomic percentages of Si and C.

Applications, respectively, for these materials include (1) repair of serviced or damaged superalloy turbine components, or manufacture of superalloy structures; (2) a metallic interconnect for a fuel cell; (3) a metallic interconnect for the anodic side of a fuel cell; (4) a sensor for measuring properties such as temperature or strain; a high temperature turbine coating or blade tips; (5) an insulating dielectric coating; (6) a fuel-reforming structure in a fuel cell; (7) a metal/ceramic composite interconnect for a fuel cell; (8) a sensor for use on a polymeric fiber-reinforced composite; (9) a ceramic composite hot gas path component in a turbine or a high-temperature fuel cell.

The following Examples are illustrative and should not be construed as a limitation on the scope of the claims unless a limitation is specifically recited.

### EXAMPLE

Three Ni-based materials were obtained in gas-atomized powder form with a nominal maximum powder particle diameter of 16 microns. Two first material examples were similar to superalloy compositions (Ni976 and Ni977 batch numbers). One second material (low-melt) example (Ni978) was a Ni alloy with high Si and B content for melting point suppression. The weight percents and atomic percents for each of these alloys are shown in TABLE 1. Blending these powders in different volume percentages of first material and second material result in over-all blend compositions that are proportional to the volume fractions of each material. Thus, in TABLE 2, over-all compositions are shown (in atomic percent) for blends of 10%, 25% and 50% of second material with each example of first material, and for a blend of 70% of second material with just one of the first materials (powder blends A-G).

TABLE 1

| | wt. % | at. % | wt % | at. % | wt. % | at. % |
|---|---|---|---|---|---|---|
| Co | 3.13 | 3.0 | 7.5 | 7.3 | 15 | 12.5 |
| Cr | 7.57 | 8.3 | 12.92 | 14.2 | 19.7 | 18.4 |
| Al | 7.76 | 16.4 | 6.3 | 13.4 | 5 | 9.0 |
| B | 0.01 | 0.1 | 0.003 | 0.02 | 0.55 | 2.5 |
| C | 0.03 | 0.1 | 0.04 | 0.2 | 0.02 | 0.1 |
| Si | 0.53 | 1.1 | 0.06 | 0.1 | 9 | 15.6 |
| W | 3.96 | 1.2 | 3.52 | 1.1 | | |
| Ta | 5.52 | 1.7 | 4.92 | 1.6 | | |
| Re | 1.6 | 0.5 | 1.52 | 0.5 | | |
| Hf | 0.15 | 0.05 | 0.15 | 0.05 | | |
| Zr | 0.001 | 0.0006 | | | | |
| Ni | 69.739 | 67.6 | 63.067 | 61.5 | 50.73 | 42.0 |

| | | |
|---|---|---|
| Ni976 “1^{st}” #1 | Ni977 “1^{st}” #2 | Ni978 “2nd” |

TABLE 2

| | Powder | Powder | Powder | Powder | Powder | Powder | Powder |
|---|---|---|---|---|---|---|---|
| at. % | A | B | C | D | E | F | G |
| Co | 7.9 | 4.0 | 8.6 | 5.4 | 9.9 | 7.8 | 9.6 |
| Cr | 14.6 | 9.3 | 15.3 | 10.8 | 16.3 | 13.3 | 15.4 |
| Al | 12.9 | 15.6 | 12.3 | 14.5 | 11.2 | 12.7 | 11.2 |
| B | 0.3 | 0.3 | 0.6 | 0.7 | 1.2 | 1.3 | 1.7 |
| C | 0.2 | 0.1 | 0.2 | 0.1 | 0.1 | 0.1 | 0.1 |
| Si | 1.7 | 2.5 | 4.0 | 4.7 | 7.8 | 8.3 | 11.2 |
| W | 1.0 | 1.1 | 0.8 | 0.9 | 0.5 | 0.6 | 0.4 |
| Ta | 1.4 | 1.6 | 1.2 | 1.3 | 0.8 | 0.9 | 0.5 |
| Re | 0.4 | 0.4 | 0.4 | 0.4 | 0.2 | 0.2 | 0.1 |
| Hf | 0.04 | 0.04 | 0.04 | 0.04 | 0.02 | 0.02 | 0.01 |
| Zr | | 0.001 | | 0.0005 | | 0.0003 | 0.0002 |
| Ni | 59.6 | 65.0 | 56.7 | 61.2 | 51.8 | 54.8 | 49.7 |
| 2^{nd} | 10% | 10% | 25% | 25% | 50% | 50% | 70% |
| Material | 978 | 978 | 978 | 978 | 978 | 978 | 978 |
| 1st | 90% | 90% | 75% | 75% | 50% | 50% | 30% |
| Material | 977 | 976 | 977 | 976 | 977 | 976 | 976 |

Powder blends A-G were prepared as Inks A-G by mixing the powders with appropriate amounts of ethyl cellulose and alpha terpineol to provide an ink that flowed easily through nozzle 16, yet retained an as-written line shape with minimal change in dimension. Ink components are listed in grams in TABLE 3.

Several lines were written on Ni substrates for each ink and the written lines were heat treated in argon for 2 hours at 1200° C. The average height and width of lines written with each ink are shown in TABLE 4, both for an as-written line and after heat treatment. Ratios were calculated to represent the change in height and width as porosity level was reduced by liquid-assisted densification.

TABLE 3

| | grams in ink | | | | | | |
|---|---|---|---|---|---|---|---|
| | INK A | INK B | INK C | INK D | INK E | INK F | INK G |
| Ethyl | 2.57 | 2.19 | 3.46 | 1.97 | 2.95 | 2.97 | 2.58 |
| Cellulose | | | | | | | |
| Terpineol - | 24.63 | 22.40 | 28.47 | 19.90 | 31.54 | 31.20 | 34.89 |
| Alpha | | | | | | | |
| Ni976 | | 198.00 | | 164.70 | | 110.60 | 65.99 |
| Ni977 | 198.00 | | 164.90 | | 110.60 | | |
| Ni978 | 21.80 | 21.90 | 55.10 | 55.30 | 110.10 | 110.60 | 154.79 |
| % CARRIER | 0.11 | 0.10 | 0.13 | 0.09 | 0.14 | 0.13 | 0.15 |

TABLE 4

| | Line Dimensions (in.) | | | | | | |
|---|---|---|---|---|---|---|---|
| | INK A | INK B | INK C | INK D | INK E | INK F | INK G |
| As-Deposited | | | | | | | |
| Height | 0.014 | 0.020 | 0.020 | 0.016 | 0.009 | 0.004 | 0.009 |
| Width | 0.035 | 0.036 | 0.035 | 0.025 | 0.033 | 0.034 | 0.030 |
| 1200° C./2 h/ | | | | | | | |
| Ar Ht. Trt. | | | | | | | |
| Height | 0.011 | 0.018 | 0.009 | 0.014 | 0.003 | 0.003 | 0.002 |
| Width | 0.025 | 0.038 | 0.054 | 0.035 | 0.036 | 0.036 | 0.042 |
| Ratio of Ht. Trt./ | | | | | | | |
| As-Dep | | | | | | | |
| Height | 0.8 | 0.9 | 0.5 | 0.9 | 0.3 | 0.8 | 0.2 |
| Width | 0.7 | 1.1 | 1.5 | 1.4 | 1.1 | 1.1 | 1.4 |
| Ratio of Ratios Ht/Wdth | 1.1 | 0.9 | 0.3 | 0.6 | 0.3 | 0.7 | 0.2 |

| | | | |
|---|---|---|---|
| 10% low-melt | 25% low-melt | 50% low-melt | 70% |

The heat treatment resulted in a reduced height for each ink line (ratio less than 1.0), resulting in an increased width for all but one ink line (ratio greater than 1.0), due to the liquid second material allowing settling and spreading. For inks A and B, with only 10% of the low-melting second material, the lines reduced in volume due to densification but retained an as-written shape, as indicated by the close to 1.0 height to width ratios (1.1 and 0.9, respectively). Lines from inks C-G showed ratios of 0.2 to 0.7, indicating a substantial change in line shape after heat treatment.

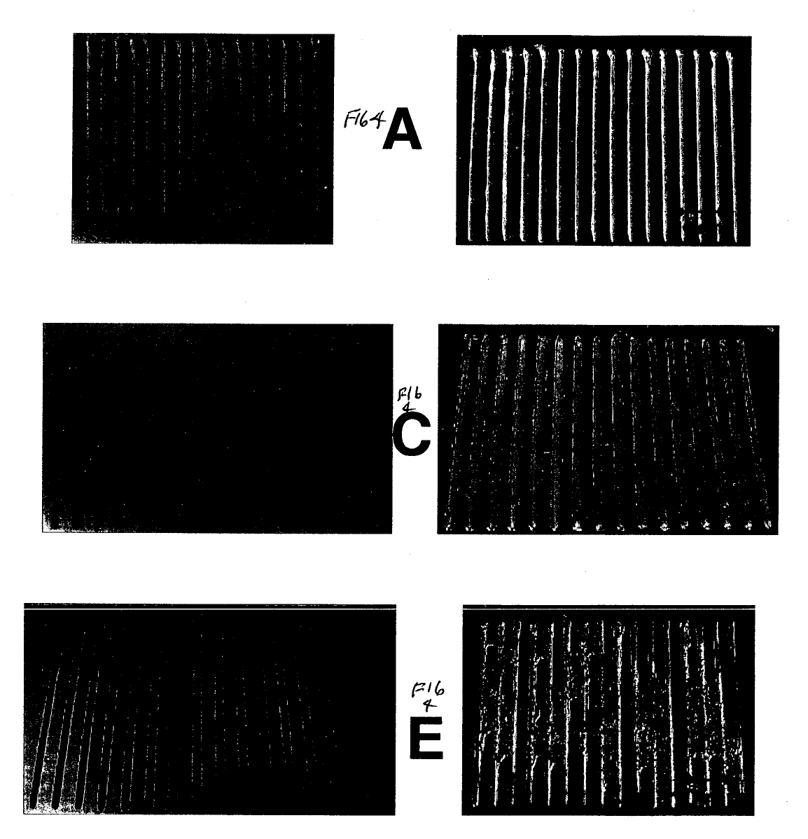

FIG. 4 shows the surfaces of lines written with inks A through G. The FIG. 4 shows as-written lines on the left and the same lines following 2 hours in argon at 1200° C. heat treatment on the right. Inks A, C, and E include 10, 25 and 50% of second material blended with first material #2 from Table 1. Inks B, D, F and G include 10, 25, 50 and 70% of second material blended with first material #1 from TABLE 1. Heat treated inks E-G show pronounced spreading indicating wetting. Inks C and D show somewhat less pronounced wetting. As-written lines A and B are virtually replicated in shape, but shrunken by densification, after heat treatment.

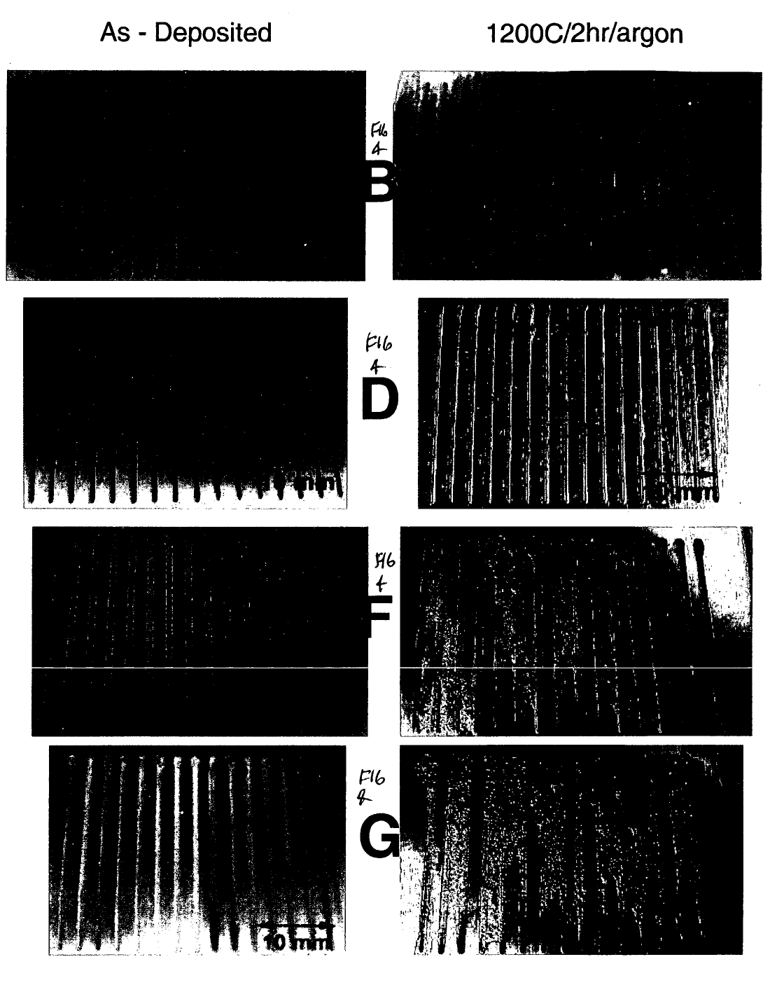

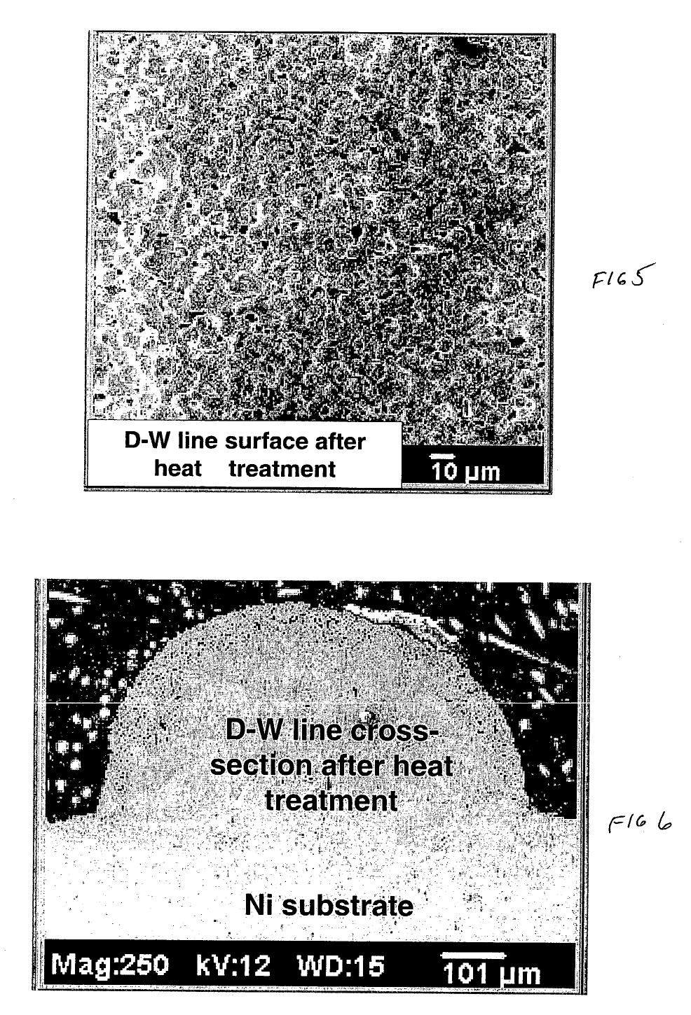

FIG. 5 is a 1000 magnification micrograph of an Ink B line surface after heat treatment and FIG. 6 is a 250 magnification cross section micrograph of an Ink B line after heat treatment. The FIG. 5 surface micrograph indicates that there is potentially much porosity present after heat treatment, but the cross section in FIG. 6 shows nearly complete densification. Densification is important for both repair applications and structure-building applications. The FIGS. 5 and 6 indicate that the process of the invention eliminates large defects that could lead to pre-mature cracking under an applied load. The cross section shows an homogeneous microstructure (verified with x-ray mapping for the critical elements) and it also shows excellent joining of the written line to the substrate after heat treatment. This is also important for structural applications.

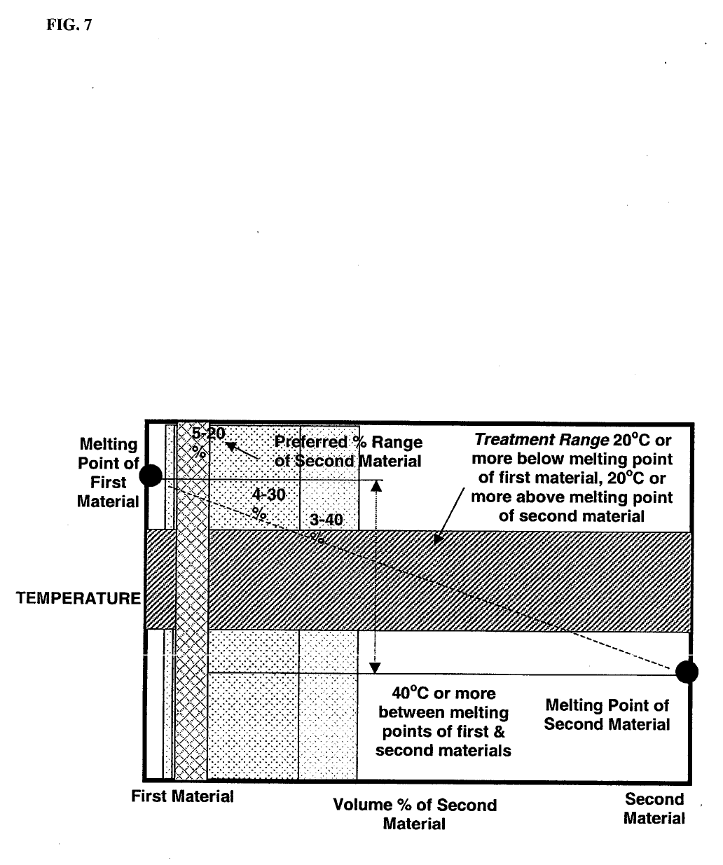

In FIG. 7, the abscissa is 100% first material at the left, 100% second material at the right, so that any position along the abscissa represents the percent of second material in a given combination. The ordinate is a schematic representation of the melting temperatures of the first and second materials and their combinations. For the EXAMPLE materials illustrated in FIG. 4, the temperatures of melting for first and second materials are 1260° C. & 1100° C., respectively. FIG. 7 shows a dotted line between melting points of the first and second invention prescribed treatment range. The dotted line indicates an expected trend in melting temperature as a function of percent second material. Each particular combination of first material and second material composition will have its own melting point variation as a function of percent second material composition. For the powder blends of the EXAMPLE, first materials had melting temperatures of about 1260° C. and second material composition had a melting temperature of about 1100° C. The 1200° C. processing temperature was about 60° C. less than the first material melting temperature and approximately 100° C. more than the second material melting temperature.

Inks E and F, with 50% second material composition, showed excessive liquation and spreading (FIG. 4). There was sufficient second material composition in these Inks to nearly fully dissolve the first materials and remain in a liquid+solid range at the processing temperature. This result indicates a suitable 3 to 40% second material composition for this processing temperature. At the low end of the range, processing temperature should be close to the upper temperature limit to provide a dense structure. At the upper end of the range, processing temperature should be closer to the lower temperature limit to provide a dense structure. Retaining shape and producing >96% of theoretical density for a blend of 5% second material (for the specific alloys of TABLE 1) requires a processing temperature of approximately 1230° C. for four hours. Retaining shape and producing >96% of theoretical density for 40% second material requires a processing temperature of approximately 1150° C. for ten hours. Retaining shape and producing ˜85% of theoretical density for a blend of 5% second material composition (for the specific alloys of TABLE 1) requires a processing temperature of approximately 1230° C. for thirty minutes. Retaining shape and producing ˜85% of theoretical density (15% residual porosity) at 40% second material composition requires a processing temperature of approximately 1150° C. for one hour. A range of 4-30% second material composition is more desirable for processability. This range reduces sensitivity of the densification rate to processing conditions. A preferred range is 5-20% second material composition. The preferred range will provide shape consistency to the structures of inks A and B (10% second material composition), compared to inks C and D (25% second material composition).

While preferred embodiments of the invention have been described, the present invention is capable of variation and modification and therefore should not be limited to the precise details of the EXAMPLE. For example, although the invention has been described in terms of materials that can be deposited onto a substrate as a single phase, additionally the materials can be used to form multilayer coatings or composite articles. The invention includes changes and alterations that fall within the purview of the following claims.

What is claimed is:

1. A method to apply a material layer, comprising:
selecting a first material with a first melting temperature and a second material composition having a second melting temperature at least 40° C. lower than the first melting temperature;
forming a suspension comprising the first material and second material composition in a carrier medium;
depositing the suspension onto a surface to form a layer; and
controllably heating the layer to a temperature at least 20° C. above the melting temperature of the second material composition but no higher than 20° C. below the melting temperature of the first material, to dissolve at least some of the first material in melted second material composition.

2. The method of claim 1, wherein the second material composition comprises a combined second material with a melting temperature suppressant, the combination having a second melting temperature at least 40° C. lower than the first melting temperature.

3. The method of claim 1 wherein the second material composition comprises a combined second material with a melting temperature suppressant, the combination having a second melting temperature at least 40° C. lower than the first melting temperature wherein controllably heating the layer melts some first material to dilute the melting temperature suppressant to raise the melting temperature of the second material composition.

4. The method of claim 1, wherein the second material melting temperature is at least 80° C. below that of the first material.

5. The method of claim 1, wherein the second material melting temperature is at least 120° C. below that of the first material.

6. The method of claim 1, comprising forming a suspension comprising particles of <25 microns in average particle size.

7. The method of claim 1, comprising forming a suspension comprising particles of <10 microns in average particle size.

8. The method of claim 1, comprising forming a suspension comprising particles of <5 microns in average particle size.

9. The method of claim 1, wherein at least one of the materials is <1.0 micron in average particle size.

10. The method of claim 1, comprising forming a suspension comprising from about 60 to 96 weight percent first material and second material composition.

11. The method of claim 1, comprising forming a suspension comprising from about 70 to 94 weight percent first material and second material composition.

12. The method of claim 1, comprising forming a suspension comprising from about 80 to 92 weight percent first material and second material composition.

13. The method of claim 1, wherein at least one of the materials is a ceramic material.

14. The method of claim 1, comprising sequentially depositing the suspension to form a layer and controllably heating the layer to layer-wise fabricate a three-dimensional structure.

15. The method of claim 1, comprising depositing the suspension to form a layer to repair a part.

16. The method of claim 1, comprising controllably heating the layer to maintain temperature of the combined second material with dissolved first material until <15% porosity is attained.

17. The method of claim 1, comprising controllably heating the layer to maintain temperature of the combined second material with dissolved first material until <10% porosity is attained.

18. The method of claim 1, comprising controllably heating the layer to maintain temperature of the combined second material with dissolved first material until <4% porosity is attained.

19. The method of claim 1, further comprising removing the carrier medium by heating one hour at 700° C.

20. The method of claim 1, further comprising removing the carrier medium by heating one hour at 400° C.

21. The method of claim 1, further comprising removing the carrier medium by heating one hour at 150° C.

22. The product of the process of claim 1.

23. A composition of matter, comprising:
a first material with a first melting temperature and a second material composition having a second melting temperature at least 40° C. lower than the first melting temperature and a carrier medium.

24. The composition of claim 23, wherein the second material composition comprises a combined second material with a melting temperature suppressant, the combination having a second melting temperature at least 40° C. lower than the first melting temperature.

25. The composition of claim 23, comprising successively applied first material and second material composition layers forming a three-dimensional structure.

26. The composition of claim 23, comprising applied first material and second material composition layer repairing a part.

27. The composition of claim 23, comprising about 60 to about 96 weight percent combined first and second material particles.

28. The composition of claim 23, comprising about 70 to about 94 weight percent combined first and second material particles.

29. The composition of claim 23, comprising about 80 to about 92 weight percent combined first and second material particles.

30. The composition of claim 23, comprising a Ni-base superalloy powder first material with a melting point in excess of 1225° C. and a Ni-base lower-melt alloy second material composition including a melting point suppressing additive selected from Si, B, Ti, Cr, Pd, Au and Ga.

31. The composition of claim 23, comprising a Ni powder first material with a melting point of about 1450° C. and a Mn, Ni-base lower-melt alloy second material composition.

32. The composition of claim 23, comprising a platinum group metal first material with melting point in excess of 1500° C. and a lower-melt second material composition comprising Au, Ag, Au alloy or Ag alloy.

33. The composition of claim 23, comprising a ceramic first material with melting point in excess of 1300° C. and a lower-melting second material composition.

34. The composition of claim 23, comprising a ceramic first material with melting point in excess of 1300° C. selected from an alumina, magnesia and non-oxide ceramic and a lower-melting oxide second material composition.

35. The composition of claim 23, comprising a mixture of a conductive oxide with an Fe, Cr-base stainless steel first material with melting point in excess of 1300° C. and an Fe, Cr-base stainless steel powder with a melting point suppressant second material composition.

36. The composition of claim 23, comprising a Ag-base powder with melting point in excess of 800° C. first material and a lower-melt Bi-Sn alloy or Bi-Cd alloy second material composition.

37. The composition of claim 23, comprising a fibrous ceramic first material with melting point in excess of 1400° C. selected from silicon carbide, a silicon-based non-oxide, and alumina ceramic and a lower-melting second material composition.

38. A composition comprising:
a deposited free-form line of a first material with a first melting temperature and a second material composition comprising a combined second material and a melting temperature suppressant, the second material composition having a second melting temperature at least 40° C. lower than the first melting temperature, the line being controllably heated to a temperature at least 20° C. above the melting temperature of the second material but no higher than 20° C. below the melting temperature of the first material.

39. The composition of claim 38, comprising a structure having a porosity of less than 15% and a ratio of the aspect ratio of the deposited line to the aspect ratio of the controllably heated line of about 0.8:1 to about 1.2:1.

40. The composition of claim 38, comprising a structure having an homogenous phase with a density of 96% or greater of theoretical density.

41. The composition of claim 38, comprising a Ni-base superalloy comprising 4-8.5a/oCo, 9-15a/oCr, 12-16a/oAl, 0.3-0.8a/oB, 1.5-5.0a/oSi, 0.7-1.1a/oW, 1.1-1.6a/oTa, 0.3-0.5a/oRe, 0.02-0.05Hf.

42. The composition of claim 38, comprising a Ni alloy comprising 2.5-10a/o Mn.

43. The composition of claim 38, comprising a Rh-base alloy comprising (1) 20-50a/o of an element selected from Pd and Pt and combinations thereof and (2) 5-15a/o of an element selected from Au and Ag and combinations thereof.

44. The composition of claim 38, comprising alumina with 5-25 volume percent of Cr.

45. The composition of claim 38, comprising a ceramic base selected from alumina, magnesia, zirconia, yttria-stabilized zirconia, or combinations thereof, with 5-25 volume percent of a silicate glass.

46. The composition of claim 38, comprising an Fe-base alloy comprising 18-26a/oCr, 0.3-0.8a/oB, 1.5-5.0a/oSi, 0.1-1a/oTi, 0.01-0.06a/o of an element selected from La, Y, Zr, Ce, Nd, Dy, and Gd, and 10-35 volume percent of a conductive oxide selected from MnCr2O4, lanthanum strontium manganate, and lanthanum chromate.

47. The composition of claim 38, comprising a Ag-base alloy comprising 2-9a/oBi, and 2-9a/o of an element selected from Cd and Sn and combinations thereof.

48. The composition of claim 38, comprising a fibrous silicon carbide with 5-25 volume percent of a silicon carbide formed from the second material composition of equal atomic percentages of Si and C.

49. The composition of claim 38, comprising FeCrAlY with 5-30 volume percent of TiC.

50. A structure comprising consecutively deposited free-form lines produced by:
selecting a first material with a first melting temperature and a second material composition having a second melting temperature at least 40° C. lower than the first melting temperature;
forming a suspension comprising the first material and second material composition in a carrier medium;
depositing the suspension onto a surface to form a layer; and
controllably heating the layer to a temperature at least 20° C. above the melting temperature of the second material composition but no higher than 20° C. below the melting temperature of the first material, to dissolve at least some of the first material in melted second material composition.

51. A structure comprising a part repaired by depositing a free-form line according to claim 50.

52. A structure comprising a turbine component repaired by depositing a free-form line according to claim 50.

53. A structure comprising a turbine component comprising consecutively deposited free-form lines according to claim 50.

54. A structure comprising a turbine component comprising a coating comprising consecutively deposited free-form lines according to claim 50.

55. A structure comprising a turbine airfoil comprising a blade tip comprising consecutively deposited free-form lines according to claim 50.

56. A structure comprising an interconnect for a fuel cell comprising consecutively deposited free-form lines according to claim 50.

57. A structure comprising a fuel cell comprising components comprising consecutively deposited free-form lines according to claim 50.

58. A structure comprising a property-measuring sensor comprising consecutively deposited free-form lines according to claim 50.

59. A structure comprising a property-measuring sensor comprising an insulating dielectric coating comprising consecutively deposited free-form lines according to claim 50.

60. A structure comprising a ceramic composite hot gas path turbine component comprising consecutively deposited free-form lines according to claim 50.
